(19) United States
(12) Patent Application Publication
(10) Pub. No.: US 2008/0137644 A1
(43) Pub. Date: Jun. 12, 2008

(54) METHODS AND APPARATUS TO PROVIDE VOICE OVER INTERNET PROTOCOL (VoIP) SERVICES

(76) Inventors: Douglas F. Reynolds, Austin, TX (US); Jeffrey L. Brandt, Cedar Park, TX (US); Aaron Bangor, Austin, TX (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/608,953

(22) Filed: Dec. 11, 2006

(51) Int. Cl. H04L 12/66

(52) U.S. Cl. 370/352

(57) ABSTRACT

Methods and apparatus to provide voice over Internet protocol (VoIP) services are disclosed. An example method comprises initiating a voice over Internet protocol (VoIP) session to a service entity, initiating a data transfer session to the service entity based upon a parameter associated with the VoIP session, the data transfer session to occur during a first time period, the VoIP session occurring during a second time period at least partially overlapping the first time period, and transferring account information to the service entity via the data transfer session.

### FIELD OF THE DISCLOSURE

This disclosure relates generally to telecommunications and, more particularly, to methods and apparatus to provide voice over Internet protocol (VoIP) services.

### BACKGROUND

The amount and/or speed of information conveyed during voice conversations and/or telephone calls may be limited by the speed at which persons can speak and/or manually enter, provide and/or make inputs and/or selections. Additionally, in some instances, a person may be required to manually enter, provide, make and/or speak relatively large amounts of data including, for example, user account information and/or user validation information (e.g., a password, a personal identification number (PIN), an account number, a user name, an account name, a government identification number, a social security number, a credit card number, an address, and/or a phone number) when interacting with a service entity (e.g., a customer service terminal, a technical support terminal, an order entry terminal, a coupon service, a billing system terminal, and/or a human service representative and/or technician operating the same).

### BRIEF DESCRIPTION OF THE DRAWINGS

FIG. 1 is a schematic illustration of an example voice over Internet protocol (VoIP) communication system constructed in accordance with the teachings of the invention.

FIG. 2 illustrates an example manner of implementing any or all of the example VoIP devices and/or the example service entity of FIG. 1.

FIG. 3 illustrates an example manner of implementing any or all of the example session modules of FIG. 1.

FIG. 4 illustrates an example data structure that may be used to implement any or all of the example telephone number (TN) to session initiation protocol uniform resource identifier databases (TN to SIP URI database) of FIGS. 1 and/or 2.

FIG. 5 illustrates an example data structure that may be used to initiate a data transfer session.

FIG. 6 is a flowchart representative of example machine readable instructions which may be executed to implement any or all of the example session modules and/or, more generally, any or all of the example VoIP devices and/or the example service entity of FIGS. 1 and/or 2.

### DETAILED DESCRIPTION

Methods and apparatus to provide voice over Internet protocol (VoIP) services are disclosed. A disclosed example method includes initiating a voice over Internet protocol (VoIP) session to a service entity, initiating a data transfer session to the service entity based upon a parameter associated with the VoIP session, the data transfer session to occur during a first time period, the VoIP session occurring during a second time period at least partially overlapping the first time period, and transferring account information to the service entity via the data transfer session. Another disclosed example method includes initiating a voice over Internet protocol (VoIP) session to a VoIP device via a first VoIP protocol message, and initiating a data transfer session to the VoIP device via a second VoIP protocol message, the data transfer session to be separate from the VoIP session. A disclosed example apparatus includes a voice over Internet Protocol (VoIP) processor to initiate a VoIP session to a service entity via a first VoIP protocol message, and a session module to initiate a data transfer session to the service entity via a second VoIP protocol message and to transfer account information to the service entity via the data transfer session, the data transfer session to occur during a first time period, the VoIP session occurring during a second time period at least partially overlapping the first time period.

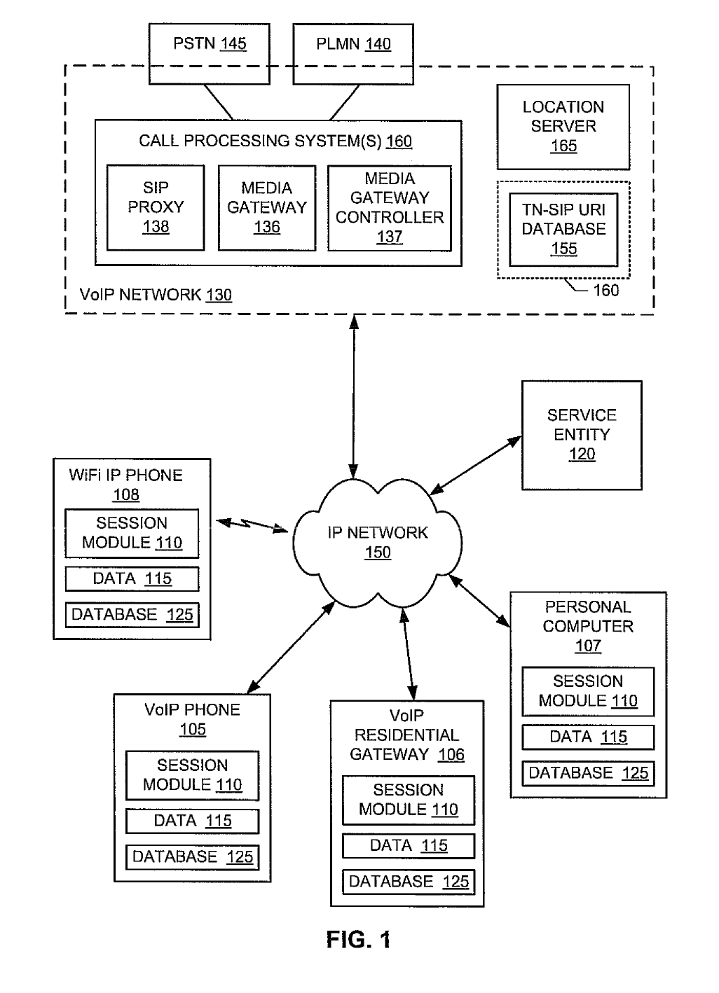

FIG. 1 is a schematic illustration of an example VoIP communication system constructed in accordance with the teachings of the invention. In the interest of brevity and clarity, throughout the following disclosure references will be made to the example VoIP communication system, VoIP networks, VoIP devices, service entities and/or VoIP services of FIG. 1. However, it should be understood that the methods and apparatus to provide enhanced communication services disclosed herein are applicable to other types of communication services, networks, technologies and/or systems such as public switched telephone network (PSTN) systems, wireless distribution systems, wired or cable distribution systems, coaxial cable distribution systems, Ultra High Frequency (UHF)/Very High Frequency (VHF) radio frequency systems, satellite or other extra-terrestrial systems, cellular distribution systems, power-line broadcast systems, fiber optic networks, and/or combinations and/or hybrids of these devices, systems and/or networks.

Further, while disclosed examples discussed herein utilize session initiation protocol (SIP) exchanges, messages and/or techniques to initiate, establish and/or modify VoIP communication sessions and/or data transfer sessions, any number and/or type(s) of communication protocol(s), message(s), exchange(s) and/or technique(s) for initiating, establishing and/or modifying communication sessions and/or data transfer sessions may be utilized. For example, any past, current and/or future media gateway control protocol (MGCP) standard and/or specification, such as the International Telecommunication Union (ITU) H.248 standard may be employed.

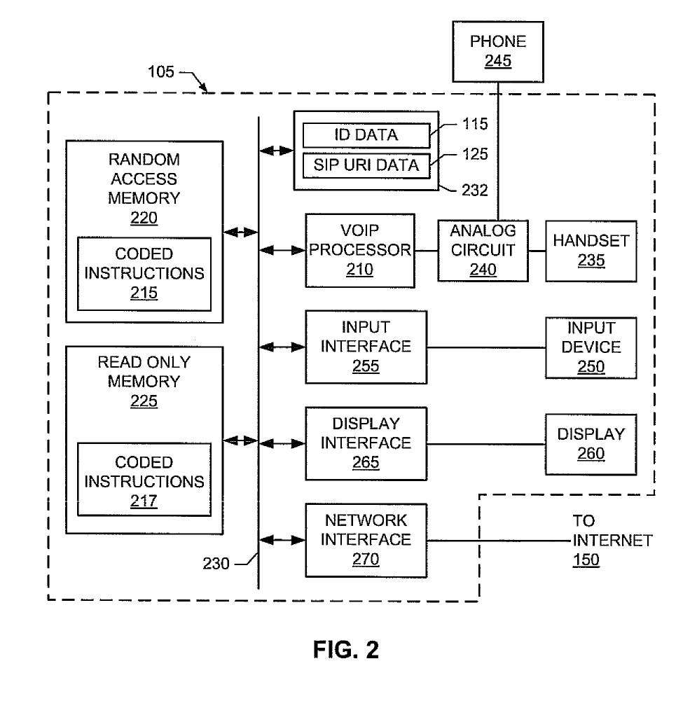

To allow users to, for example, place and/or receive a VoIP based communication (e.g., a telephone service, Internet service, data service, messaging service, instant messaging service, electronic mail (email) service, chat service, video service, audio service, gaming service, etc.), the example communication system of FIG. 1 includes one or more VoIP devices, four of which are illustrated in FIG. 1 with reference numerals 105, 106, 107 and 108. The example VoIP devices 105, 106, 107 and 108 of FIG. 1 may be any type(s) of VoIP devices including, for example, a corded and/or cordless VoIP phone 105, a VoIP residential gateway 106, a VoIP enabled personal computer 107, a VoIP endpoint, a wireless VoIP device 108 (e.g., a wireless-fidelity (WiFi) Internet protocol (IP) phone), and/or a VoIP adapter (e.g., an analog telephone adapter (ATA)). An example manner of implementing any or all of the example VoIP devices 105, 106, 107 and 108 of FIG. 1 is described below in connection with FIG. 2.

As illustrated in FIG. 1, each of the example VoIP devices 105, 106, 107 and 108 includes a session module 110. The example session modules 110 of FIG. 1 are configured to establish one or more communication sessions in parallel with and/or in addition to one or more VoIP communication sessions. Such parallel and/or secondary communication sessions may be additional VoIP communication sessions or any type(s) of data session and/or data transfer session implemented using, for example, Internet protocol (IP) based communication, universal datagram protocol (UDP) based communication, transmission control protocol (TCP) based communication, TCP/IP based communication, file transfer protocol (FTP) communication, and/or hyper-text markup language (HTML) based communication. Example data that may be exchanged and/or transmitted via a data transfer session includes, but is not limited to, digital pictures, audio, video, data files, advertisements, coupons, website information, etc. Data transfer sessions may also be used to send and/or exchange any number and/or type(s) of account information and/or user validation information 115 (e.g., a password, a personal identification number (PIN), an account number, a user name, an account name, a government identification number, a social security number, a credit card number, an address, and/or a phone number) at substantially the same time that the corresponding VoIP device 105-108 and/or a user of the VoIP device 105-108 is interacting with a service entity 120 (e.g., a customer service terminal, a technical support terminal, an order entry terminal, a coupon service, a billing system terminal, and/or a human service representative and/or technician operating one or more of such terminals). In some examples, data transfer sessions and/or data transmitted via a data transfer session may be encrypted for security. The example data 115 of FIG. 1 may be stored in device 105-108 using any number and/or type(s) of data structures such as, for example, a so called Internet “cookie.” The example service entity 120 of FIG. 1 may be, in some examples, implemented similarly to the example VoIP devices 105-108.

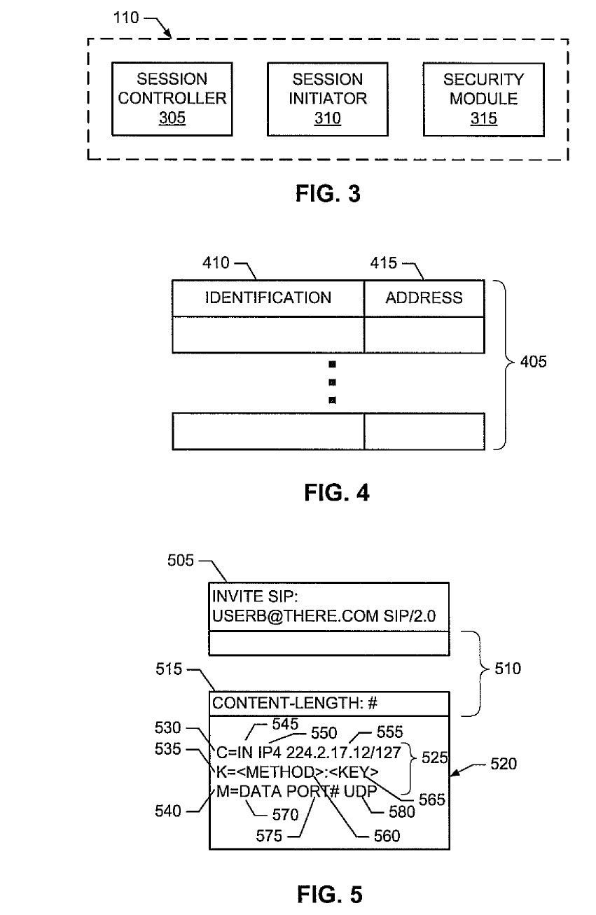

Parallel and/or secondary data communication session(s) may be initiated and/or established during and/or after the establishment of a VoIP communication session, and as directed and/or initiated by a user of a VoIP device 105-108 and/or an application implemented by and/or within the VoIP device 105-108. For example, a user may initiate the secondary and/or parallel communication session by pressing one or more general purpose and/or dedicated keys and/or buttons of an input interface, such as a keyboard, keypad and/or touch screen of the device 105-108. For instance, an input interface may include a dedicated button to initiate a secure data transfer session that may be used to transmit user and/or device identification information 115 to any type of service entity 110. An application implemented by and/or within a VoIP device 105-108 may initiate the secondary and/or parallel communication session by using an application programming interface (API) implemented by and/or provided by its session module 110. An example manner of implementing any or all of the example session modules 110 is described below in connection with FIGS. 3 and 5.

The example session modules 110 of FIG. 1 initiate and/or establish secondary and/or parallel communication sessions by (a) obtaining any type of applicable address for another VoIP device 105-108 and/or a telephone number, and (b) using the obtained address to establish the parallel and/or second communication session. For example, two session modules 110 may (a) exchange IP addresses and/or session initiation protocol (SIP) uniform resource identifiers (URIs) assigned to respective VoIP devices 105-108 and/or telephone numbers via one or more SIP messages, and (b) use the IP addresses and/or SIP URIs to initiate and/or establish an IP-based communication session that is used by the VoIP devices 105-108 to exchange any number and/or type(s) of data in parallel with the VoIP communication session. The parallel and/or secondary data communication session may be established via any number and/or type(s) of protocols, such as TCP/IP, UDP, and/or SIP. That is, the secondary and/or parallel communication session need not be established using SIP, even if a SIP protocol message is used to initiate the secondary and/or parallel communication session. An example data structure that may be used to exchange and/or convey addresses via a SIP INVITE message is described below in connection with FIG. 5. In another example, two session modules 110 transmit any number and/or types(s) of signals within the VoIP communication session to initiate and/or establish the parallel and/or secondary data communication session. Example signals include, but are not limited to Baudot encoded signals, modem signals and/or dual-tone multiple-frequency (DTMF) signals. Because such in-band signals (i.e., transmitted by and/or within the VoIP communication session) may interfere with a service occurring via the VoIP communication session, the example session modules 110 of FIG. 1 first attempt to locate an address for a VoIP device 105-108 that can be used to establish the parallel and/or secondary data communication session before using in-band signals.

To store addresses that may be used to establish a secondary and/or parallel communication sessions, each of the example VoIP devices 105-108 of FIG. 1 includes a database 125. The example databases 125 of FIG. 1 include addresses and/or identifiers for respective VoIP devices 105-108 (e.g., SIP URIs). In the example system of FIG. 1, the databases 125 are indexed based upon telephone numbers (TN) associated with and/or assigned to VoIP devices 105-108. However, the databases 120 may be indexed using any number and/or type(s) of values. An example data structure that may be used to implement the example database 125 is described below in connection with FIG. 4.

While the example VoIP devices 105-108 of FIG. 1 include session modules 110, data 115 and/or databases 125 that implement substantially similar functionality, a particular session module 110, data 115 and/or database 125 implemented by any of the VoIP devices 105-108 may differ in any way(s) from a session module 110, data 115 and/or database 125 implemented by any other VoIP device 105-108. For example, a first example session module 110 (e.g., implemented by the example PC 107) may be implemented as machine accessible instructions executed by a processor, while a second example session module 110 (e.g., implemented by the example VoIP phone 105) is implemented as any combination of firmware, hardware and/or logic. Further, one or more of the VoIP devices 105-108 need not include a session module 110. Moreover, the example session modules 110, data 115 and/or database 125 may differ in the number and/or type(s) of features they implement and/or perform.

To provide VoIP communication services, the example system of FIG. 1 includes any number and/or type(s) of VoIP communication networks, one of which is illustrated in FIG. 1 with reference numeral 130. To initiate, receive, establish, complete and/or route any type(s) of VoIP communication sessions and/or VoIP telephone calls with, to and/or between the example VoIP devices 105-108, the example VoIP communication network 130 of FIG. 1 may communicate with and/or contain any portion of any number and/or type(s) of call processing system(s) 135. The call processing system(s) 135 and/or VoIP networks 130 may be operated by one or more service providers.

In the example communication system illustrated in FIG. 1, the call processing system(s) 135 are implemented using an architecture commonly referred to in the industry as a “soft-switch architecture” in that a first server (e.g., a media gateway 136) implements the actual transmitting, receiving and/or transcoding of communication session data, while a second server (e.g., a media gateway controller 137) implements the signaling, control, logic and/or protocol(s) to initiate, route and/or establish VoIP communication sessions. However, any type(s) of call processing system architecture(s) may be implemented. For example, the call processing system(s) 135 may be implemented in accordance with a past, current and/or future 3^{rd} Generation Partnership Program (3GPP) Internet Multimedia Subsystem (IMS) standard and/or specification, and/or may be implemented using, for example, session border controllers, call processors, call serving controllers, etc.

The example call processing system(s) 135 of FIG. 1 can include one or more optional SIP Proxies 138 to assist with the processing and/or routing of SIP messages and/or SIP exchanges that are used by VoIP devices 105-108 and/or the service entity 120 to initiate and/or establish VoIP communication sessions, and/or parallel and/or secondary data communication sessions.

As illustrated in FIG. 1, the example VoIP communication network 130 may include an interface to and/or contain any portion of a public land mobile network (PLMN) 140 (i.e., a cellular communication network), an interface to and/or contain any portion of a PSTN 145, and/or an interface to and/or contain a portion of any number and/or type(s) of additional communication networks, such as an Internet Protocol (IP) network 150 (e.g., the Internet). For example, using any number and/or type(s) of technique(s), method(s), protocol(s) and/or technology(-ies), the call processing system(s) 135 and the PSTN 145 can facilitate telephone calls between a PSTN-based phone (not shown) and any of the example VoIP devices 105-108.

The example PLMN 140 and/or the example PSTN 145 of FIG. 1 may be implemented by any number and/or type(s) of communication device(s), switch(es), protocol(s), system(s) and/or technology(-ies). For instance, the example PLMN 140 may include any number of cellular base stations that can transmit cellular signals to and/or receive cellular signals from a cellular communication device (not shown) using any type(s) of protocols (e.g., time-division multiple access (TDMA), code-division multiple access (CDMA), orthogonal frequency-division multiple access (OFDM), etc.).

In the illustrated example of FIG. 1, the example VoIP devices 105-108 are communicatively coupled to the example VoIP communication network 130 via any number and/or type(s) of public and/or private IP networks 150 such as the Internet. However, any number and/or type(s) of past, current and/or future communication network(s), communication system(s), communication device(s), transmission medium(s), protocol(s), technique(s), specification(s) and/or standard(s) could be used to couple the VoIP devices 105-108 to the VoIP communication network 130. Interfaces between the VoIP devices 105-108 and the IP network 150, and/or the VoIP communication network 130 and the IP network 150 may be implemented using any number and/or type(s) of past, current and/or future device(s), technology(-ies) and/or method(s). For instance, the example VoIP devices 105-108 may be coupled to the IP network 150 via any type(s) of voice-band modem(s), digital subscriber line (DSL) modem(s), cable modem(s), Ethernet transceiver(s), optical transceiver(s), IP virtual private network (VPN) connection(s), Institute of Electrical and Electronics Engineers (IEEE) 802.11x (a.k.a. WiFi) transceiver(s), IEEE 802.16 (a.k.a. WiMax), access point(s), etc. Moreover, the example IP network 150 of FIG. 1 may extend geographically to include a location near to and/or encompassing a VoIP device 105-108. For example, the IP network 150 may include a wireless access point (not shown) by which, for example, the example WiFi IP phone 108 connects to the IP network 150.

To store and/or record addresses that may be used to initiate and/or establish parallel and/or secondary data communication sessions, the example VoIP communication network 135 of FIG. 1 includes a telephone number (TN) to session initiation protocol (SIP) uniform resource identifier (URI) (TN to SIP URI) database 155. The example database 155 of FIG. 1 includes addresses and/or identifiers for respective VoIP devices 105-108. In the example system of FIG. 1, the database 155 is indexed based upon telephone numbers (TN) associated with and/or assigned to VoIP devices 105-108. However, the database 155 may be indexed using any number and/or type(s) of values. In the example system of FIG. 1, when a session module 110 can not locate a SIP URI for a VoIP device 105-108 in its local database 125, the session module 110 can query the TN to SIP URI database 155 in an attempt to locate and/or obtain an address (e.g., a SIP URI) for the VoIP device 105-108.

The example TN to SIP URI database 155 of FIG. 1 may be implemented using any number and/or type(s) of data structures, such as a line information database (LIDB) and/or in accordance with a home subscriber server (HSS) database. An example data structure that may be used to implement the example database 155 of FIG. 1 is described in connection with FIG. 4. In the illustrated example of FIG. 1, the database 155 is stored in any number and/or type(s) of data storage device(s) and/or memory(-ies) 160.

While one TN to SIP URI database 155 is illustrated in FIG. 1, persons of ordinary skill in the art will readily appreciate that there may be any number and/or type(s) of databases 155 that may be distributed and/or shared amongst one or more call processing system(s) 135 and/or one or more VoIP networks 130.

Additionally or alternatively, the example VoIP communication network 130 of FIG. 1 may include any number and/or type(s) of location servers 165. The example location server 165 of FIG. 1 is implemented as an HSS that provides an interface to the example TN to SIP URI database 155.

While an example VoIP communication network 130 has been illustrated in FIG. 1, the devices, networks, systems, and/or processors illustrated in FIG. 1 may be combined, divided, re-arranged, eliminated and/or implemented in any other manner. For example, the example call processing system(s) 135 and the example location server 165 illustrated in FIG. 1 may be logical entities of the example VoIP communication network 130 and, thus, need not be implemented separately. Further, any or all of the example VoIP devices 105-108, the example session modules 110, the example call processing system(s) 135 and/or, more generally, the example VoIP communication network 130 of FIG. 1 may be implemented by hardware, software, firmware and/or any combination of hardware, software and/or firmware. Moreover, the example VoIP communication network 130 may include additional servers, systems, networks, gateways, portals, and/or processors than those illustrated in FIG. 1, and/or may include more than one of any or all of the illustrated devices, servers, networks, systems, gateways, portals, and/or processors.

FIG. 2 illustrates an example manner of implementing any or all of the example VoIP devices 105-108 and/or the example service entity 120 of FIG. 1. While any of the example VoIP devices 105-108 and/or the example service entity 120 may be represented by FIG. 2, for ease of discussion, the example device of FIG. 2 will be referred to as VoIP device 105. To handle VoIP processing functions, the example VoIP device 105 of FIG. 2 includes any number and/or type(s) of VoIP processors 210. The example VoIP processor 210 of FIG. 2 implements, among other things, session control, VoIP protocols, a SIP user agent, and a coder (not shown) to encode audio and/or video signals, a decoder (not shown) to decode received audio and/or video signals, a packetizer (not shown) to packetize encoded data and a de-packetizer (not shown) to de-packetize encoded data.

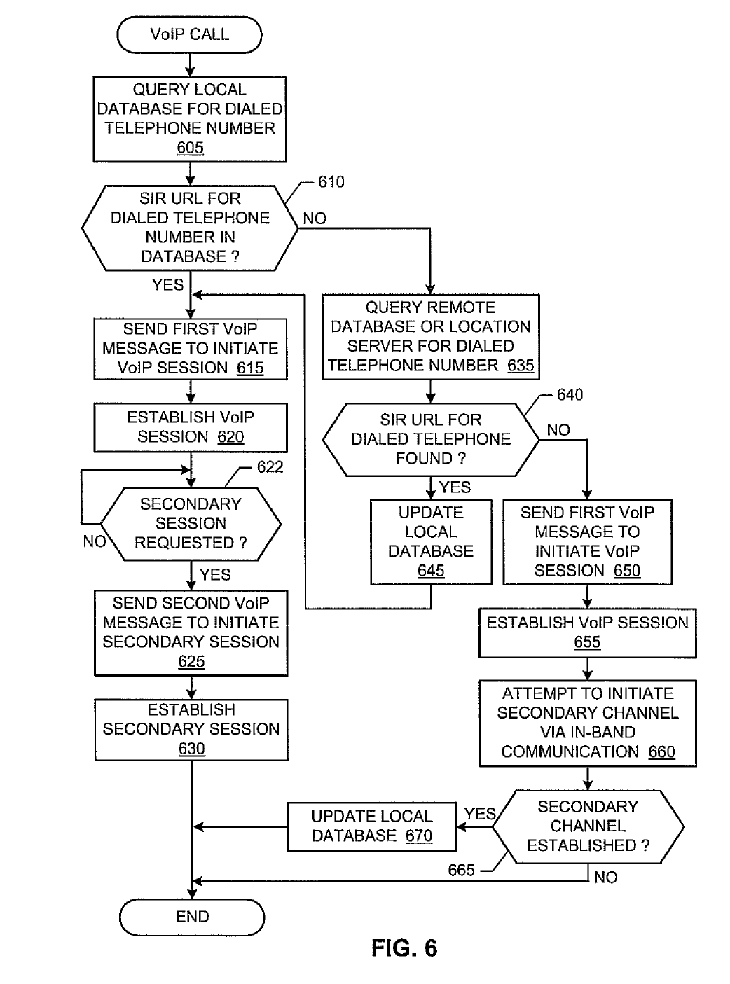

In addition to any number and/or type(s) of specialized hardware, firmware and/or logic to perform VoIP processing functions, the example VoIP processor 210 of FIG. 2 may include any number and/or type(s) of specialized and/or general purpose controller(s) and/or processing unit(s) capable of executing coded instructions. For example, the controller and/or processing unit may perform any number and/or type(s) of VoIP processing functions by carrying out and/or executing coded instructions 215 and/or 217 present in a main memory of the VoIP processor 210 (e.g., within a random-access memory (RAM) 220, a read-only memory (ROM) 225 and/or on-board memory of the VoIP processor 210). For example, all or some of the coded instructions 215 and/or 217 may be executed to implement the example session module 110 of FIG. 1, and/or the example machine accessible instructions discussed below in connection with FIG. 6. Additionally or alternatively, any or all of the example session module 110 of FIG. 1, and/or the example machine accessible instructions of FIG. 6 may be implemented as hardware, software firmware and/or logic and/or any combination(s) of hardware, software, firmware and/or logic within the VoIP processor 210 and/or, more generally, within the example VoIP device 105 of FIG. 2.

The example VoIP processor 210 is in communication with the main memory (including a read-only memory (ROM) 225 and/or the RAM 220) and other devices and/or modules of the example VoIP device 105 of FIG. 2 via any type(s) and/or number of buses 230. The example RAM 220 may be implemented by, for example, dynamic random-access memory (DRAM), synchronous dynamic random-access memory (SDRAM), and/or any other type of RAM device(s). The example ROM 225 may be implemented by, for example, flash memory(-ies) and/or any other desired type of memory device(s). Access to the example memory 220 and 225 is typically controlled by a memory controller (not shown). Additionally or alternatively, the example RAM 220 and/or example ROM 225 of FIG. 2 may be used to store data 115 received by and/or transmitted by the example VoIP device 105 of FIG. 2 via a data communication session operated substantially in parallel to a VoIP communication session and/or via the VoIP communication session. By “substantially in parallel,” this patent is indicating that the primary communication session operates during a time interval that at lease partially overlaps with a second time interval during which the data communication session takes place.

To store the example data 115 and/or the example TN to SIP URI database 125 of FIG. 1, the example VoIP device 105 of FIG. 2 includes any number and/or type(s) of data stores 232. The example data store 232 of FIG. 2 may be implemented by any number and/or type(s) of memory device(s) such as a flash memory. The example data store 232 may be implemented by the RAM 222 or the ROM 225 or may be a system memory device.

To electrically couple signals (e.g., speech signals) between a handset 235 and the example VoIP processor 210, the example VoIP device 105 of FIG. 2 includes any number and/or type(s) of analog circuits 240. An example analog circuit 240 includes any number and/or type(s) of filter(s), analog-to-digital converter(s) and/or digital-to-analog converter(s) to convert between analog signals sent to and/or received from an example handset 235 and digital signals sent to and/or received from the example VoIP processor 210. The handset 235 can be corded or cordless.

If a cordless handset 235 is to be employed, the example analog circuit 240 of FIG. 2 is implemented with any number and/or type(s) of wireless communication technologies to communicatively couple the example VoIP processor 210 with any type of cordless handset 235. Moreover, the example analog circuit 240 of FIG. 2 may, additionally or alternatively, implement any number and/or type(s) of subscriber line interface circuits (SLICs) that allow any number and/or type(s) of corded and/or cordless PSTN-based telephones 245 to be electrically coupled to the example VoIP processor 210 of FIG. 2. The latter example could be used, for instance, in implementations where the example VoIP device 105 is located in and/or implements a VoIP analog telephone adapter (ATA) and/or residential gateway (RG).

To facilitate user inputs via any type of input device 250 (e.g., a keypad, a keyboard and/or a touch screen), the example VoIP device 105 of FIG. 2 includes any type of input interface 255. The example input interface 255 of FIG. 2 electrically couples and/or translates electrical signals conveying key and/or button press information from the example input device 250 to the example VoIP processor 210. The example input interface 255 and/or the example input device 250 may be used by a user to initiate and/or establish a parallel and/or secondary data communication session that may be used by, for example, the VoIP processor 210 and/or any application implemented by and/or within the example VoIP device 105 to send, for instance, the example user and/or device identification (ID) data 115 to a service entity (e.g., the example service entity 120 of FIG. 1).

To provide output information to a user via any number and/or type(s) of displays 260, the example VoIP device 105 of FIG. 2 includes any number and/or type(s) of display interfaces 265. An example display interface 265 receives information (e.g., alphanumeric characters) to be displayed from the example VoIP processor 210 and creates electrical signals suitable for displaying the information on the example display 260. The display 260 of the illustrated example is a liquid-crystal display (LCD) screen. The example display interface 265 and/or the example display 260 may also be used to, for example, display pictures, text (e.g., alphanumeric characters) and/or video received by the example VoIP device 105 via a parallel and/or secondary data communication session.

To communicatively couple the example VoIP device 105 to the example IP network 150 of FIG. 1, a local-area network (LAN), a modem, a router, a bridge and/or a gateway, the example VoIP device 105 includes any number and/or type(s) of network interfaces 270. The example network interface(s) 270 of FIG. 2 implement any number and/or type of communication and/or data interface(s) in accordance with any past, current and/or future standards such as Ethernet, DSL, WiMax, WiFi, cable modems, etc.

While an example VoIP device 105 is illustrated in FIG. 2, the VoIP device 105 may be implemented using any number and/or type(s) of other and/or additional processors, devices, components, circuits, modules, interfaces, etc. Further, the processors, devices, components, circuits, modules, elements, interfaces, etc. illustrated in FIG. 2 may be combined, divided, re-arranged, eliminated and/or implemented in any of a number of ways. Additionally, any or all of the example VoIP device 105 may be implemented as any combination of firmware, software, logic and/or hardware. Moreover, the example VoIP device 105 may include additional processors, devices, components, circuits, interfaces and/or modules in addition to those illustrated in FIG. 2 and/or may include more than one of any or all of the illustrated processors, devices, components, circuits, interfaces and/or modules.

FIG. 3 illustrates an example manner of implementing any or all of the example session modules 110 of FIG. 1. To initiate and/or establish parallel and/or secondary data communication sessions, the example session module 110 of FIG. 3 includes a session controller 305 and a session initiator 310. The example session controller 305 of FIG. 3 receives and/or processes inputs that direct and/or cause the session controller 305 to direct and/or prompt the example session initiator 310 to initiate and/or establish a parallel and/or secondary data communication session.

In response to such an input, the example session controller 305 of FIG. 3 (a) obtains an applicable address for a VoIP device 105-108 at the other end of a VoIP communication session, and (b) instructs example session initiator 310 to initiate and/or establish a data transfer session that operates in parallel to the VoIP communication session to and/or with the VoIP device 105-108. The parallel data transfer session is initiated between the VoIP device 105-108 and a device associated with the other end. Typically, the device associated with the other address is a part of the VoIP communication, but a parallel session could be initiated by a different device. The example session controller 305 of FIG. 3 can obtain an address of the VoIP device 105-108 via a local telephone number (TN) to SIP URI database (e.g., the example database 125 of FIGS. 1 and/or 2), one or more central and/or shared TN to SIP URI databases (e.g., the example database 155), and/or via a location server (e.g., the example location server 165). The example session initiator 310 of FIG. 3 may (a) exchange IP addresses and/or SIP URLs via one or more SIP messages, and (b) use the IP addresses and/or SIP URLs to initiate and/or establish an IP based communication session that the VoIP device 105-108 uses to exchange any number and/or type(s) of data in parallel with the VoIP communication session. While the example session initiator 310 uses one or more SIP messages to exchange IP addresses and/or SIP URIs, the session initiator 310 need not use SIP to establish the parallel and/or secondary data communication session. Moreover, the example session initiator 310 may exchange IP addresses and/or SIP URIs, and/or initiate a secondary and/or parallel communication session via any other protocols and/or messages, such as TCP/IP. An example data structure that may be used to implement a SIP INVITE message that can be used to initiate and/or establish the parallel and/or secondary data communication session is described below in connection with FIG. 5.

When an address for the other VoIP device 105-108 (i.e., the VoIP device to which and/or from which the data transfer session is to occur) is not available, the example session controller 305 of FIG. 3 instructs and/or directs the example session initiator 310 to transmit any number and/or types(s) of signals within the VoIP communication session to initiate and/or establish the parallel and/or secondary data communication session. Example signals include, but are not limited to Baudot encoded signals, modem signals and/or DTMF signals. Because such in-band signals (i.e., transmitted by and/or within the VoIP communication session) may interfere with a service occurring via the VoIP communication session, the example session controller 305 of FIG. 3 first attempts to locate an address for the VoIP device 105-108 that can be used to establish the parallel and/or secondary data communication session before using in-band signals. The parallel and/or secondary session does not interfere with the VoIP communication session because, once established, data for the parallel and/or secondary session is transported using a different data stream than that used to transport the VoIP communication session.

To provide security for a data transfer session, the example session module 110 of FIG. 3 includes any number and/or type(s) of security modules 315. The example security module 315 of FIG. 3 is configured to encrypt data transmitted via a secondary and/or parallel communication session and/or to decrypt data received via a secondary and/or parallel communication session. However, not all data received via and/or transmitted via a secondary and/or parallel communication session need be encrypted. For example, user and/or device identification data (e.g., the example data 115 of FIGS. 1 and/or 2) when sent to a service entity (e.g., the example service entity 120) is encrypted, while picture data transmitted between two VoIP devices 105-108 is not encrypted. Additionally or alternatively, the example security module 315 encrypts user and/or device identification and/or authentication data 115 before it is stored. In such an example, the security module 315 not need to encrypt the data 115 before it is sent to a service entity 120.

While an example session module 110 is illustrated in FIG. 3, the example session module 110 may be implemented using any number and/or type(s) of other and/or additional processors, devices, components, circuits, modules, interfaces, etc. Further, the processors, devices, components, circuits, modules, elements, interfaces, etc. illustrated in FIG. 3 may be combined, divided re-arranged, eliminated and/or implemented in any of a variety of ways. Additionally, the example session module 110 may be implemented as any combination of firmware, software, logic and/or hardware. For example, the example session module 110 may be implemented as coded instructions (e.g., the example coded instructions 215 and/or 217) executed by, for example, the example VoIP processor 210 of FIG. 2. Moreover, the example session module 110 may include additional processors, devices, components, circuits, interfaces and/or modules than those illustrated in FIG. 3 and/or may include more than one of any or all of the illustrated processors, devices, components, circuits, interfaces and/or modules.

FIG. 4 illustrates an example data structure that may be used to implement any or all of the example telephone number (TN) to SIP URI databases 115, 155 of FIGS. 1 and/or 2. The example data structure of FIG. 4 contains a plurality of entries 405 for respective ones of a plurality of communication session endpoints (e.g., the example VoIP devices 105-108 and/or the example service entity 120). To identify the corresponding endpoint, each of the entries 405 of FIG. 4 includes a destination identification field 410. The example destination identification field 410 of FIG. 4 contains a value and/or alphanumeric string that uniquely identifies the corresponding endpoint, such as a telephone number URI (e.g., a 10-digit telephone number).

To specify an address, each of the example entries 405 of FIG. 4 includes an address field 415. The example address field 415 of FIG. 4 contains one or more values and/or alphanumeric strings that represents, for example, a SIP URI (e.g., SIP: new_service_testor@voip.com), a uniform resource locator (URL), and/or an IP address.

While an example data structure is illustrated in FIG. 4, the example data structure may be implemented using any number and/or type(s) of other and/or additional fields and/or data. Further, the fields and/or data illustrated in FIG. 4 may be combined, divided, re-arranged, eliminated and/or implemented in any of a variety of ways. Moreover, the example data structure may include additional fields and/or data than those illustrated in FIG. 4 and/or may include more than one of any or all of the illustrated fields and/or data. For example, additional fields may be present that contain additional and/or alternative addresses for a VoIP device 105-108.

FIG. 5 illustrates an example data structure that may be used to implement a SIP message containing SDP information that may be used to initiate and/or establish a parallel and/or secondary data communication session. To identify the SIP message, the example data structure of FIG. 5 includes a name field 505. The example name field 505 of FIG. 5 includes an alphanumeric string that identifies the SIP message and identifies a destination for the example message. The example SIP message illustrated in FIG. 5 is a SIP INVITE message and, thus, the example name field 505 contains a string that includes “INVITE”. In the illustrated example, the SIP message is addressed to userb@there.com. Persons of ordinary skill in the art will readily recognize that the name field 505 could be used to identify any type of message to any applicable destination.

To provide additional values and/or parameters, the example data structure of FIG. 5 includes one or more header fields 510. Example header fields 510 include, but are not limited to, a “from” field, a caller identification field, a command sequence number field, and/or a length field 515. The number of header fields 510, in some examples, depends upon the type of SIP message and/or the protocol(s) implemented by either endpoint. The example length field 515 of FIG. 5 contains a value that represents the length (possibly zero) of a payload 520 of the example data structure. The example payload 520 of FIG. 5 may be used to carry any number and/or type(s) of additional or alternative information applicable to the message.

To convey session negotiation information, the example payload 520 of FIG. 5 includes SDP information 525. The example SDP information 525 of FIG. 5 describes and/or specifies one or more possible parameters of a secondary data communication session being initiated that will operate independently from and/or in parallel with a VoIP communication session in which a corresponding VoIP device 105-108 is currently engaged. The example SDP information 525 of FIG. 5 includes one or more connection information fields 530, one or more encryption information fields 535, and one or more media information fields 540. The example connection information field 530 of FIG. 5 specifies a network type 545 of IN for Internet, and an address type 550 of IP version 4 address. It also specifies an IP address 555 of 224.2.17.12. The example encryption information field 535 of FIG. 5 specifies an encryption method 560 and an encryption key 565. However, if the parallel and/or secondary data communication session is not encrypted, the encryption information field 535 may not be present and/or may include a null set. The example media information field 540 of FIG. 5 specifies a connection type 570 of DATA, a port number 575 and a protocol type 580 of UDP. Persons of ordinary skill in the art will readily recognize that the SDP information 525 could specify additional sessions and/or attributes.

While an example data structure is illustrated in FIG. 5, the example data structure may be implemented using any number and/or type(s) of other and/or additional fields and/or data. Further, the fields and/or data illustrated in FIG. 5 may be combined, divided, re-arranged, eliminated and/or implemented in any of a variety of ways. Moreover, the example data structure may include additional fields and/or data than those illustrated in FIG. 5 and/or may include more than one of any or all of the illustrated fields and/or data.

FIG. 6 is a flowchart representative of example machine accessible instructions that may be executed to implement any or all of the example session modules 110, the example VoIP devices 105-108 and/or the example service entity 120 of FIGS. 1, 2 and/or 3. The example machine accessible instructions of FIG. 6 may be executed by a processor, a controller and/or any other suitable processing device. For example, the example machine accessible instructions of FIG. 6 may be embodied in coded instructions stored on a tangible medium such as a flash memory, a ROM and/or RAM associated with a processor (e.g., the example processor 210 discussed above in connection with FIG. 2). Alternatively, some or all of the example flowchart of FIG. 6 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example flowchart of FIG. 6 may be implemented manually or as any combination(s) of any of the foregoing techniques, for example, any combination of firmware, software, discrete logic and/or hardware. Further, although the example machine accessible instructions of FIG. 6 are described with reference to the flowchart of FIG. 6 persons of ordinary skill in the art will readily appreciate that many other methods of implementing the example session modules 110, the example VoIP devices 105-108 and/or the example service entity 120 of FIGS. 1, 2 and/or 3 may be employed. For example, the order of execution of the blocks may be changed, and/or some of the blocks described may be changed, eliminated, sub-divided, or combined. Additionally, persons of ordinary skill in the art will appreciate that the example machine accessible instructions of FIG. 6 may be carried out sequentially and/or carried out in parallel by, for example, separate processing threads, processors, devices, discrete logic, circuits, etc.

The example machine accessible instructions of FIG. 6 begin when a VoIP communication session is being initiated by a session module (e.g., the example session module 110 of FIGS. 1 and/or 3), a VoIP device (e.g., any of the example VoIP devices 105-108) and/or a service entity (e.g., the example service entity 120). While the example machine accessible instructions of FIG. 6 may be executed by any or all of a session module, a VoIP device and/or a service entity, for ease of discussion, in the following description the machine accessible instructions of FIG. 6 will be executed by a session module.

The session module (e.g., the example session controller 305 of FIG. 3) queries a local TN to SIP URI database (e.g., the example database 125 of FIGS. 1, 2 and/or 4) to local a SIP URI for the telephone number being called (block 605). If the local TN to SIP URI database contains a SIP URI for the telephone number (block 610), a VoIP processor (e.g., the example VoIP processor 210 of FIG. 2) sends a first VoIP protocol message (e.g., a SIP INVITE message) to the VoIP device associated with the telephone number (TN) to initiate the VoIP communication session (block 615) and then completes a SIP exchange to establish the VoIP communication session (block 620).

When a secondary data communication session has been requested and/or initiated by a user (block 622), the session controller directs and/or instructs a session initiator (e.g., the example session initiator 310) to establish the data communication session that operates in parallel to the VoIP communication session by, for example, sending another VoIP protocol message (e.g., the example SIP INVITE message of FIG. 5) to the SIP URI obtained from the local TN to SIP URI database (block 625). Alternatively, the session initiator may use any other protocol, such as TCP/IP, to initiate the parallel communication session. The session initiator completes the establishment of the parallel and/or secondary data communication session (block 630). Control then exits from the example machine accessible instructions of FIG. 6.

Persons of ordinary skill in the art will readily appreciate that blocks 625, 630 may be carried out in parallel with blocks 615, 620 such that the VoIP communication session and the parallel and/or secondary data communication session are initiated and/or established in parallel or the same or substantially the same time.

Returning to block 610, if the local TN to SIP URI database does not contain a SIP URI for the telephone number (block 610), the session controller queries a remote database (e.g., the example TN to SIP URI database 155 of FIG. 1) and/or a location server (e.g., the example location server 165) to obtain a SIP URI for the telephone number (block 635). If a SIP URI for the telephone number is obtained (block 640), the session controller updates its local TN to SIP URI database with the obtained SIP URI (block 645). Control then proceeds to block 615 to initiate and establish the VoIP communication session and, if requested, a parallel and/or secondary data communication session.

If a SIP URI for the telephone number is not obtained (block 640), the VoIP processor sends a first VoIP protocol message (e.g., a SIP INVITE message) to the VoIP device associated with the telephone number (TN) to initiate the VoIP communication session (block 650) and then completes the SIP exchange to establish the VoIP communication session (block 655).

The session controller then directs and/or instructs the session initiator to establish a second communication session that operates in parallel to the VoIP communication session by, for example, sending an in-band signal such as one or more of a Baudot encoded signal, a modem signal and/or a DTMF signal within the VoIP communication session to initiate and/or establish the parallel and/or secondary data communication session (block 660). For example, the session initiator may use in-band signaling to obtain an IP address and/or SIP URI for the VoIP device and then use out-of-band signaling such as TCP/IP and/or SIP to complete the establishment of the parallel and/or secondary data communication session. As used herein, an in-band signal is a signal carried within and/or instead of other data being transported within the VoIP communication session, and an out-of-band signal is a signal that is carried outside of and/or separate from the VoIP communication session. An out-of-band signal may be transported and/or communicated using a same frequency as the VoIP communication session. As such, an in-band signal is not distinguished from an out-of-band signal based upon frequency, but rather based upon whether the signal is transported within the VoIP communication session. If the secondary channel is established (block 665), the session controller updates its local TN to SIP URI database with the IP address and/or SIP URI (block 620). Control then exits from the example machine accessible instructions of FIG. 6. If the secondary channel is not established (block 665), control exits from the example machine accessible instructions of FIG. 6 without updating the local TN to SIP URI database.

Although example implementations have been described, persons of ordinary skill in the art will recognize that there are numerous ways to modify these examples, for instance, the order, size, and proportions of the memory illustrated in the example systems may vary. Additionally, although this patent discloses example systems including, among other components, software or firmware executed on hardware, it will be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, persons of ordinary skill in the art will readily appreciate that the above described examples are not the only way to implement such systems.

At least some of the above described example methods and/or apparatus are implemented by one or more software and/or firmware programs running on a computer processor. However, dedicated hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of the invention are not limited to such devices, standards and/or protocols. Such systems are periodically superseded by faster or more efficient systems having the same general purpose. Accordingly, replacement devices, standards and/or protocols having the same general functions are equivalents which are intended to be included within the scope of the accompanying claims.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method comprising:
initiating a voice over Internet protocol (VoIP) session to a service entity;
initiating a data transfer session to the service entity based upon a parameter associated with the VoIP session, the data transfer session to occur during a first time period, the VoIP session occurring during a second time period at least partially overlapping the first time period; and
transferring account information to the service entity via the data transfer session.

2. (canceled)

3. A method as defined in claim 1, further comprising encrypting the data transfer session.

4. A method as defined in claim 1, further comprising receiving a user input, the data transfer session initiated in response to the user input.

5. A method as defined in claim 4, wherein receiving the user input comprises receiving a signal from a data transfer initiation button.

6. A method as defined in claim 1, wherein initiating the data transfer session comprises:
providing a first Internet protocol (IP) address to the service entity; and
receiving a second IP address from the service entity.

7. A method as defined in claim 6, further comprising establishing an IP communication session based on the first and second IP addresses.

8. (canceled)

9. A method as defined in claim 6, wherein the first IP address is provided within a first VoIP protocol message, and the second IP address is provided within a second VoIP protocol message.

10. A method as defined in claim 9, wherein the first VoIP protocol message comprises a session initiation protocol (SIP) INVITE message.

11. A method as defined in claim 1, wherein initiating the data transfer session comprises:
determining if a uniform resource identifier (URI) is available for the service entity; and
requesting the data transfer session by sending an in-band signal within the VoIP session when the URI is not available.

12. A method as defined in claim 11, further comprising initiating the data transfer session via an out-of-band signal.

13. A method as defined in claim 11, further comprising initiating the data transfer session via an out-of-band signal when the URI is available.

14. A method as defined in claim 11, wherein the out-of-band signal is a transmission control protocol (TCP)/IP data packet.

15. A method as defined in claim 1, wherein the service entity comprises at least one of a customer service terminal, a technical support terminal, an order entry terminal, a coupon service, or a billing system terminal.

16. A method as defined in claim 1, wherein the account information comprises at least one of a password, a personal identification number (PIN), an account number, a user name, an account name, a government identification number, a social security number, a credit card number, an address, or a phone number.

17. A method as defined in claim 1, wherein the account information is an encrypted data structure.

18. A method as defined in claim 1, further comprising encrypting the data transfer session.

19. An apparatus comprising:
a voice over Internet Protocol (VoIP) processor to initiate a VoIP session to a service entity via a first VoIP protocol message; and
a session module to initiate a data transfer session to the service entity via a second VoIP protocol message and to transfer account information to the service entity via the data transfer session, the data transfer session to occur during a first time period, the VoIP session occurring during a second time period at least partially overlapping the first time period.

20. An apparatus as defined in claim 19, wherein the apparatus comprises at least one of a VoIP phone, a VoIP residential gateway, a personal computer, a VoIP endpoint or a VoIP adapter.

21. An apparatus as defined in claim 19, further comprising an input device to receive an input to request the data transfer session.

22. An apparatus as defined in claim 21, wherein the input device is at least one of a button or key.

23. (canceled)

24. An apparatus as defined in claim 19, wherein the account information comprises at least one of a password, a personal identification number (PIN), an account number, a user name, an account name, a government identification number, a social security number, a credit card number, an address, or a phone number.

25. An apparatus as defined in claim 19, further comprising a secure storage to store the account information.

26. An apparatus as defined in claim 19, wherein the VoIP destination comprises at least one of a customer service terminal, a technical support terminal, an order entry terminal, a coupon service, or a billing system terminal.

27. An apparatus as defined in claim 19, wherein the session module comprises:
a session initiator to obtain an address for the service entity based upon a parameter associated with the first VoIP protocol message and to initiate the data transfer session by sending the second VoIP protocol message; and
a session controller to send the user information via the data transfer session.

28. An apparatus as defined in claim 19, wherein the session module comprises a security module to encrypt the account information.

29. An article of manufacture storing machine readable instructions which, when executed, cause a machine to:
initiate a voice over Internet protocol (VoIP) session to a service entity;
initiate a data transfer session to the service entity based upon a parameter associated with the VoIP session, the data transfer session to occur during a first time period, the VoIP session occurring during a second time period at least partially overlapping the first time period; and
transfer account information to the service entity via the data transfer session.

30. An article of manufacture as defined in claim 29, wherein the machine readable instructions, when executed, cause the machine to verify at least one of a user identity or an account based upon the transferred account information.

31. An article of manufacture as defined in claim 29, wherein the machine readable instructions, when executed, cause the machine to initiate the data transfer session by:
providing a first Internet protocol (IP) address to the service entity;
receiving a second IP address from the service entity; and
establishing an IP communication session based on the first and second IP addresses.

32. An article of manufacture as defined in claim 29, wherein the machine readable instructions, when executed, cause the machine to initiate the data transfer session by:
determining if a uniform resource identifier (URI) is available for the service entity; and
requesting the data transfer session by sending an in-band signal within the VoIP session when the URI is not available.

33. An article of manufacture as defined in claim 29, wherein the service entity comprises at least one of a customer service terminal, a technical support terminal, an order entry terminal, a coupon service, or a billing system terminal, and wherein the account information comprises at least one of a password, a personal identification number (PIN), an account number, a user name, an account name, a government identification number, a social security number, a credit card number, an address, or a phone number.

34-41. (canceled)
